(19) United States
(12) Patent Application Publication
(10) Pub. No.: US 2002/0040342 A1
(43) Pub. Date: Apr. 4, 2002

(54) Process and system for adapting the content and/or the cost of transmission and/or service operations within a data packet transmission network

(76) Inventor: Nicolas Bouthors, Meylan (FR)

Correspondence Address: Robert M. Angus, Westman, Champlin & Kelly, International Centre, 900 Second Avenue South, Suite 1600, Minneapolis, MN, 55402-3319, US

(21) Appl. No.: 09/943,423

(22) Filed: Aug. 30, 2001

(30) Foreign Application Priority Data
Sep. 7, 2000 (FR) 0011437

(51) Int. Cl. G06F 17/60

(52) U.S. Cl. 705/40

(57) ABSTRACT

The invention concerns an improvement in payment token technology allowing the adaptation of the content and/or the cost of transmission and/or service operations carried out within a data packet transmission network (4). According to the invention, at least one of the payment tokens includes, apart from an initial value representing a credit of monetary units, at least one operation adaptation datum allowing a destination unit and/or at least one debit node to adapt the content of the operations to be carried out and/or the cost actually billed to a source unit and/or to at least one credit node, for carrying out operations.

### FIELD OF THE INVENTION

The field of the invention is that of data packet transmission networks, and particularly, but not exclusively, Internet type networks.

### BACKGROUND OF THE INVENTION

Generally speaking, such networks enable sessions to be set up, each one between a source unit and a destination unit, interconnected via one or more network nodes. During each session, the destination unit and/or one or more network nodes carry out transmission and/or service operations. The destination unit and/or the node(s) carrying out the aforementioned operations are used by a network operator and/or a service provider. In the present description, by service provider is hereby also understood a content provider.

By transmission operations are understood data packet transport operations on the network. By service operations are understood every kind of operation related to the container and content of the transmitted data packets. Service operations consist for example of an encryption/decryption of the data contained in the packets, or again of an execution of an executable or interpretable code of a program or program part contained in the packets.

Transmission and/or service operations allow for example audio or video works to be broadcast over the Internet network. In this case, a customer (the source unit, for example) sends to a service provider (the destination unit, for example) a request concerning a given work, and in return the service provider returns to the customer an audio or video data file relating to the given work.

More exactly, the invention concerns the payment (also called the “billing”) for these transmission and/or service operations.

In the interests of simplification, the following discussion is mostly concerned with the Internet. It is clear however that the invention is not restricted to this particular type of network and applies more particularly to any type of data packet transmission network.

As explained in detail in patent document WO 9733404 (LELEU), the text of which is inserted here for reference, it seems difficult, if not impossible, to implement conventional payment technologies on the Internet network for operations carried out on the networks. Indeed, the Internet network does not have the centralised administration necessary to implement these conventional payment technologies, which mainly consist of billing as a function either of the length of connection between units (for a pre-set data transmission speed and distance), or of the amount of data exchanged between two units (taking into account the data transmission speed).

For this reason, the current technology of paying for operations carried out on the Internet network consists in billing only for access at a physical point on the network. As shown in the aforementioned patent document, this billing is either at a flat-rate, or it takes into account the amount of data sent to the whole network, or else the totality of the data received from the totality of the network.

Unfortunately, this current payment technology does not allow fair and equitable billing of transmission and/or service operations carried out within the Internet network. Indeed, currently, the billing of transmission and/or service operations is not a function of the path traversed by and of the transmission speed of the data packets.

Therefore, in patent document WO 9733404 (LELEU), a new technology has been proposed, called “token technology” in the remainder of the description. It is based on the insertion of payment tokens in the packet stream, and allowing each data packet conveyed by the network to settle for itself the cost of a transmission operation relating to its own transport, or the cost of a service operation relating to its own container or content.

### SUMMARY OF THE INVENTION

The general design of this token technology will now be summarised briefly, in relation to FIGS. 1 and 2. The data packet transmission network is for example the Internet network 4. The source unit S (and/or at least one node, called a credit node) includes a packet 1 send module ME and a credit gateway PC. This latter PC assigns to each sent data packet 1 a payment token 2 which has an initial value representing a credit in monetary units previously acquired (20) from a centralising monetary agency (or “Toll Centre”) 3. Each packet 1 is therefore sent (30) with the payment token 2 which is assigned to it. The destination unit D (and/or at least one node, called a debit node, located downstream of said at least one credit node) includes a packet 1 receive module MR and a debit gateway PD. The latter receives the token assigned to each packet received 1 and modifies it (40) so as to reduce its initial value by an amount representing the cost of the operations to be carried out, for the packet received 1, by the destination unit D (and/or said at least one debit node). Lastly, the destination unit D (and/or each debit node), in which is included a said debit gateway PD, requests from (50) and receives from (60) the toll centre 3, for each packet 1 received during the session, financial settlement of the representative amount.

In the remainder of the description, the modification (30) of the payment token by reduction of its initial value, is sometimes also called, more simply, “payment token collection”.

In the example shown in FIGS. 1 and 2, only the source unit S includes a credit gateway PC and only the destination unit D includes a debit gateway PD. It is clear however that, in a general way, one or more credit nodes may also (or alternatively) include a credit gateway PC and one or more debit nodes may also (or alternatively) include a debit gateway PD.

In a particular embodiment of this token technology, the source unit is used by an access provider (or ISP, for “Internet Service Provider”, or again IAP, for “Internet Access Provider”), so that subscribers to this access provider may access the data packet transmission network. Thus, the credit gateway, which is implemented at the access provider, assigns tokens to the packets (i.e. inserts tokens in the IP streams) of customers accessing some service or other offered by a service provider. A service is for example recognised by its IP address and its port number (the latter identifying to which higher level protocol the request is to be passed). Conventionally, subscribers are connected to their access provider by (at least) one other communication network, such as the switched telephone network (“fixed network”, STN) or again a radio-communication network (“mobile network”, for example according to the GSM standard).

This token technology has numerous advantages. In particular it allows fair and equitable billing of transmission and/or service operations carried out within a data packet transmission network, for example of the Internet type. It may also constitute an electronic payment means, associated with the content of the packets, in the network nodes. Indeed, the payment token assigned to each data packet makes it possible to finance any type of operation (transport and/or service) carried out by the destination unit or any network node in which the packet will reside.

Token technology provides, optionally, for an “upstream” adaptation (i.e. in the source unit or in the credit node) of the content and/or of the cost of transmission and/or service operations.

To be more exact, token technology, in its current form, provides at token creation stage (i.e. before its insertion in a packet), for the credit gateway to calculate a numerical value constituting a credit of paying units, which is a function of the number of operations which can be completed with this credit, of the service quality of these operations, and of the type of these operations. In the case of transport operations, the numerical value calculated is for example a function of the packet destination address, the number of nodes passed through or the data exchange speed. In every case, to the different packets are assigned tokens having different monetary values and calculated in a predetermined way,

However, such an “upstream” adaptation of the content and/or the cost of transmission and/or service operations is not satisfactory.

Indeed, implementing it within the credit gateway is very complex, since, to create each token, the credit gateway must of necessity be acquainted with and take account of the operation or operations which this token will finance and authorise. This complexity is further increased when the credit gateway manager is an Internet access provider for a plurality of subscribers. Each of the subscribers in fact has his/her own specificities in terms of numbers, service quality and type of operations to be carried out.

Additionally, the implication is that operations providers (typically the service providers) will continuously inform credit gateway managers of all the modifications which they intend to bring to the services (operations) which they are able to offer. But this will clearly run counter to the basic desire of service providers to remain as independent as possible of the credit gateway managers (particularly when the latter are Internet access providers).

To sum up, making an adaptation of the content and/or the cost of operations currently poses a problem. For this reason, and with a view to simplifying settlement, only an implementation with tokens of a fixed purchase value seems actually conceivable at the present time.

The particular objective of the invention is to overcome this major drawback of the prior art.

To be more exact, one of the objectives of the present invention is to provide a process and system constituting an improvement on the token technology discussed above, so that the latter may be used while allowing an easy adaptation of the content and/or the cost of transmission and/or service operations.

Another objective of the invention is to provide such a process and system, allowing the operation providers (typically the service providers) to remain as independent as possible of the credit gateway managers (typically Internet access providers).

These different objectives, and others which will emerge subsequently, are met according to the invention by means of a process for adapting the content and/or the cost of transmission and/or service operations carried out within a data packet transmission network, during a session between a source unit and a destination unit interconnected via at least one node of said network, said destination unit and/or said at least one node being used by at least one operator and/or at least one service provider. The process is such that:

in said source unit and/or in at least one node, called a credit node, a credit gateway assigns to each data packet sent by said source unit a payment token which has an initial value representing a credit of monetary units previously acquired from a toll centre;

in said destination unit and/or in at least one node, called a debit node, located downstream of said at least one credit node, a debit gateway modifies the payment token assigned to each data packet received, so as to reduce said payment token initial value, by an amount representing the cost of the operations to be carried out, for said received packet, by said destination unit and/or said at least one debit node;

said destination unit and/or each debit node, in which is included a said debit gateway, receives from said toll centre, for each packet received during said session, a financial settlement of said representative amount.

According to the invention, at least one of said payment tokens includes, apart from said initial value representing a credit of monetary units, at least one operation adaptation datum, allowing said destination unit and/or said at least one debit node to adapt the content of the operations to be carried out and/or the cost actually billed to said source unit and/or to said at least one credit node, in order to carry out said operations.

The general principle of the invention therefore consists in carrying out a “downstream” adaptation (i.e. in the debit node or in the destination unit) of the content and/or cost of the transmission and/or service operations.

In this way, the operations provider (typically the service providers managing the destination unit in which the debit gateway is included) itself manages the content and/or the cost of the operations it carries out. It thus has great freedom to customise these operations and/or their modes of billing. It remains independent of the source unit or credit node manager (typically the Internet access provider), which merely enhances the payment tokens with relevant data then inserts these payment tokens into the packets.

The operation adaptation data may be inserted in the payment tokens according to any format type, agreed between the credit gateway manager and the debit gateway manager.

Preferentially, said at least one operation adaptation datum belongs to the group including data relating to the user, direct or indirect, of said source unit and/or said at least one credit node.

By indirect user is understood particularly a subscriber to an access provider using the source unit (see detailed description below).

In a first particular embodiment of the invention, in order to adapt the actually billed cost, said destination unit and/or said at least one debit node carries out the following stages:

determination of said actually billed cost, as a function of said at least one operation adaptation datum;

reduction of said payment token initial value, by a pre-set average amount representing the average cost of the operations to be carried out;

modification of the current value of an associated account relating to a user, direct or indirect, of said source unit and/or said at least one credit node, by addition or withdrawal of a sum as a function of the difference between said actually billed cost and said pre-set average amount.

Thus, in this first embodiment, all the operations have a same cost, called an average cost, for the credit gateway. It is the destination unit or debit node manager (typically the service provider) who adapts the actually billed cost by “playing” on the current value of a buffer account. This is an account (for example pre-paid) which the credit gateway manager has with the destination unit or debit node manager, and which relates to the user concerned. For a given operation, the sum added to or withdrawn from this account is for example equal to the difference between the actually billed cost and the pre-set average amount of this given operation.

In a second particular embodiment of the invention, in order to adapt the actually billed cost, said destination unit and/or said at least one debit node carries out the following stages:

determination of said actually billed cost, as a function of said at least one operation adaptation datum;

reduction of said payment token initial value, by a pre-set average amount representing the average cost of the operations to be carried out;

return to said source unit and/or said at least one credit node of a payment token which has a value function of the difference between said actually billed cost and said pre-set average amount, so that the value of said returned payment token is restored to a user, direct or indirect, of said source unit and/or said at least one credit node.

This second embodiment differs from the first in that the destination unit or debit node manager (typically the service provider) adapts the actually billed cost by returning one or more tokens to the credit gateway manager (and not by “playing” on the current value of a buffer account).

In one advantageous embodiment of the invention, said source unit is used by a provider of access to said data packet transmission network, and allows said access to be provided to at least one subscriber to said access provider, called an indirect user. Said at least one operation adaptation datum is added to said packet by said access provider, and depends on the subscriber in respect of whom said access provider sends said packet.

In particular, this allows the service provider to remain independent of the Internet access provider, in relation to the content and cost of the operations, which he carries out for the subscribers of this access operator.

Preferentially, said stage of addition by said access provider of said at least one operation adaptation datum is billed at least partly to said destination unit and/or said at least one debit node.

To advantage, each payment token is assigned to a given packet by insertion in said packet and/or in at least one higher level encapsulating structure of said packet.

In other words, the payment token assigned to a packet is not necessarily inserted into the packet itself, but can also be inserted into a higher level protocol field.

To advantage, said data packet transmission network is a network of the Internet type.

Preferentially, said service operations belong to the group including:

information data supply operations;

video data supply operations;

audio data supply operations;

cartography data supply operations.

This list is not exhaustive. In a general way, the present invention applies to all service and/or transmission operations.

The invention also concerns a system allowing the implementation of the content and/or costs adaptation process described above. The system according to the invention includes inclusion means in at least one of said payment tokens, apart from said initial value representing a credit of monetary units, of at least one operation adaptation datum. Said destination unit and/or said at least one debit node includes adaptation means, as a function of said at least one operation adaptation datum:

of the content of the operations to be carried out;

and/or of the cost actually billed to said source unit and/or to said at least one credit node, for carrying out said operations.

Other characteristics and advantages of the invention will emerge from reading the following description of a preferential embodiment of the invention, given purely as an example and non-restrictively, and of the appended drawings.

### BRIEF DESCRIPTION OF THE DRAWINGS

FIG. 1 shows a block diagram of a particular embodiment of the payment process and system according to the prior art, allowing token technology to be clarified.

FIG. 2 shows the operation of the particular embodiment of the process and system according to the prior art given in FIG. 1, through the exchanges carried out between the source unit, the destination unit and the toll centre.

FIG. 3 shows a block diagram of a particular embodiment of the content and/or cost adaptation process and system according to the invention.

### DETAILED DESCRIPTION OF ILLUSTRATIVE EMBODIMENTS

The invention therefore concerns a process and system for adapting the content and/or cost of transmission and/or service operations carried out within a data packet transmission network.

It amounts to an improvement in token technology, the basic design of which is known to the man skilled in the art and is described in detail particularly in patent document WO 9733404 (LELEU), the text of which is inserted here for reference.

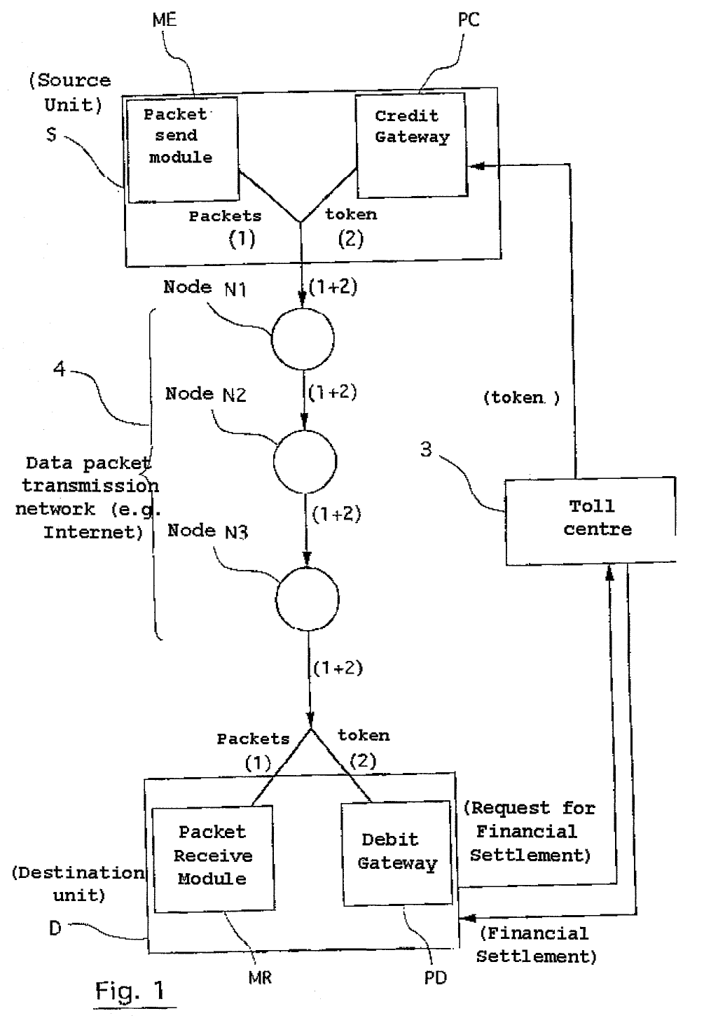

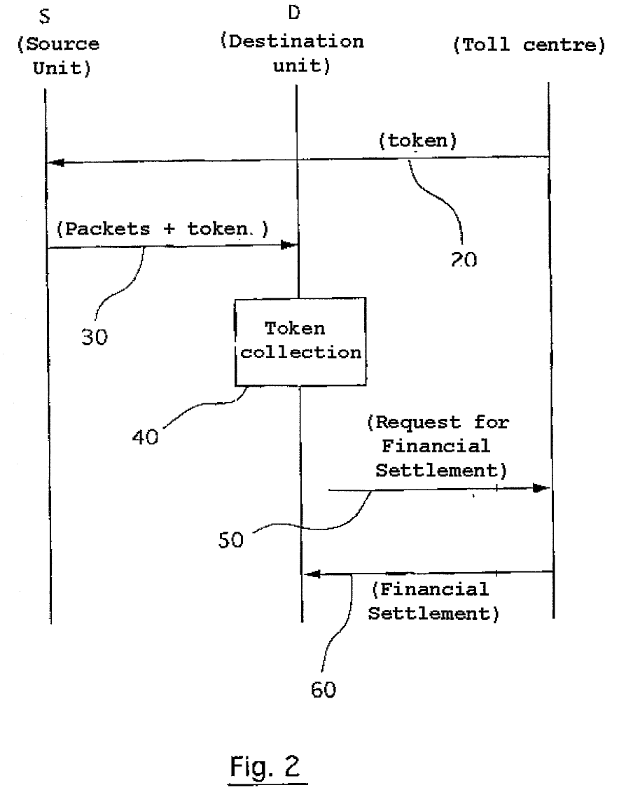

FIGS. 1 and 2, which show a particular embodiment of this known basic design, have already been discussed in the introduction of the present description.

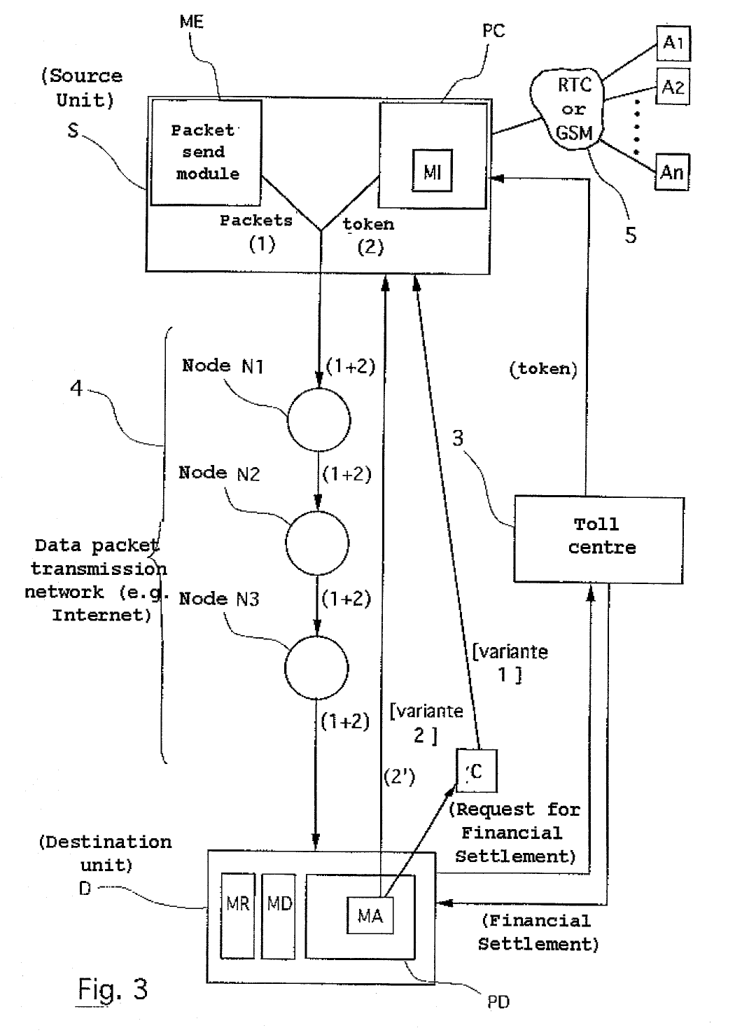

A particular embodiment of the content and/or cost adaptation process and system according to the invention is now given, in relation to FIG. 3. The elements already present in FIGS. 1 and 2 retain the same references in FIG. 3.

In this particular embodiment, the data packet transmission network is the Internet network 4. Conventionally, it includes a plurality of network nodes, including particularly those with the references N1, N2, to N3 in FIG. 3. By network node is understood any type of network unit (switch, server, router, etc.).

The source unit S is an access gateway, managed by an Internet network 4 access provider (ISP or IAP) for a plurality of subscribers A₁ to Aₙ. The latter are connected to the access gateway S of the access provider by another communication network 5 (STN or GSM for example). The access gateway S includes a module ME for sending data packets 1 on the Internet network 4, and a credit gateway PC allowing a payment token to be inserted in each packet 1 transmitted.

The tokens can be manufactured and recognised, by means of a hashing function, by the credit gateway and the debit gateway respectively. There is in this case a certain level of security.

The credit gateway PC additionally includes inclusion means MI in each payment token 2, apart from the initial value representing a credit of monetary units, of (at least) one operation adaptation datum.

These adaptation data can be inserted either in the token header or in the effective part, which already stores the monetary value. They relate for example to the subscriber for whom the packet, in which the token is inserted, is sent. It is a question for example of the identity of this subscriber, his localisation, his belonging to a user class, or any other information allowing at least one “profile”, which is specific to him, to be defined. These data may be stored and/or calculated by the access gateway S, or supplied to it by any appropriate unit (for example a GPS receiver included in the subscriber's terminal, in the case of localisation data). The insertion of adaptation data in the tokens may, at least partly, be the responsibility of the service provider.

The destination unit D is a service server, managed by a service provider, allowing for example multimedia works to be broadcast on line. More generally, the service server makes it possible to carry out one or more of the following operations:

supplying information data, for example in the form of Web pages;

supplying video data, for example in “MPG1”, “MPEG2”, “MPEG4”, “Real Video”, “AVI” and Microsoft's “ASF”, “Divx”, etc. formats;

supplying audio data, for example in “au”, “wav”, “ra”, “MP3”, “MID”, etc. formats;

supplying cartography data, for example in “SVG”, “TMF”, OptEWay's “TPF” etc. formats:

The service server D includes a data packet 1 receive module MR, means MD for broadcasting multimedia works (in response to the requests it receives), and a debit gateway PD making it possible to collect the payment tokens 2 inserted in the packets 1 which it receives.

The debit gateway PD additionally includes means MA for adapting, as a function of the aforementioned adaptation data inserted in the packet, the content of the operations to be carried out and/or the cost actually billed to the access provider for the operation concerned. The access provider undertakes to pass this cost on to the subscriber concerned by this operation.

It should be noted that the debit gateway can extract the tokens and form a billing ticket (or CDR, for “Call Detail Record”) when the (service in the present case) session ends. The credit and debit gateways thus maintain the notion of a session during the service connection time. They can condition the final allocation of tokens to the content provider on successful conclusion of the connection (of the TCP type). It is in fact a mechanism of the transactional type, with a rollback function.

By way of example, the operation of the invention is now described in the case whereby a subscriber A₁ sends a request to the service server D, via the access gateway S of the access provider, so as to receive a given work on line.

It is pre-supposed that previously, the access gateway S (i.e. the access provider) has obtained (20) from a Toll Centre 3 a plurality of payment tokens 2, each having an initial value representing a credit of monetary units.

The packet send module ME included in the access gateway S generates (at least) one data packet containing the request of the subscriber A₁. The credit gateway PC included in the access gateway S inserts into this packet 1 a payment token 2, itself containing adaptation data as presented in detail above. Alternatively, the token 2 is inserted into a higher level encapsulating structure of the packet (for example HTTP). The payment token initial value is in the present example equal to an average amount. The access gateway S sends on the Internet network 4 the packet 1 containing the token 2, intended for the service server D.

The packet 1 is received by the receive module MR of the service server. The debit gateway PD, also included in the service server, collects the payment token 2. It is in return for the latter that a financial settlement will be able to be obtained from the toll centre 3. The adaptation means, also included in the service server, extract the adaptation data contained in the token. The packet received is processed by the broadcasting means MD, possibly as a function of the adaptation data extracted from the associated token.

By way of example, two embodiment variants will now be described of the adaptation of the cost of the operation carried out by the service server.

According to a first variant of the cost adaptation, the service provider (and to be more exact the adaptation module MA included in the debit gateway PD of the service server D) carries out the following stages:

determination, as a function of the operation adaptation datum contained in the received packet 2, of the actual cost due to be billed to the access provider;

“token collection”, i.e. reduction of its initial value by a pre-set average amount, representing the average cost of the operation to be carried out. The access provider knows only this average amount. In the event of the token allowing payment of a single operation, the initial value is equal to the average amount;

modification of the current value of an account C (relating to the subscriber denoted A₁) that the access provider has with the service provider (or with a banking authority of the latter).

Modifying the current value of the aforementioned account C consists for example in adding or withdrawing a sum equal to the difference between the actual cost and the pre-set average amount. In other words, the service provider credits the account of the access provider if the actual amount is less than the average amount, or debits it in the contrary event.

According to a second variant of the cost adaptation, the service provider carries out the following stages:

determination, as a function of the operation adaptation datum contained in the received packet 2, of the actual cost due to be billed to the access provider;

“token collection” (see above);

return to the access provider (for example to the access gateway S managed by the latter) of a payment token 2′ which has a value equal the difference between the actual cost and the average amount.

Thus, the provider can restore to the subscriber denoted A₁ (for example by modifying his next bill) the value of the token 2′ which the service provider has sent back to him.

In the particular embodiment shown in FIG. 3 only the source unit S includes a credit gateway PC and only the destination unit D includes a debit gateway PD. It is clear however that the present invention applies also if one or more nodes, called credit nodes, each include a credit gateway PC and/or if one or more nodes, called debit nodes, each include a debit gateway PD.

Furthermore, in the preceding, the adaptation data relate to the content and/or the cost of a service operation. However, the present invention applies also to the adaptation of the content and/or cost of transport operations.

It should be noted that a same payment token can allow the payment of transmission operations and of service operations. In this case, the adaptation data can relate to the content and/or cost of each of these operations.

What is claimed is:

1. A process for adapting the content and/or the cost of transmission and/or service operations carried out within a data packet transmission network, during a session between a source unit and a destination unit interconnected via at least one node of said network, said destination unit and/or said at least one node being used by at least one operator and/or at least one service provider, said process being such that:
in said source unit and/or in at least one node, called a credit node, a credit gateway assigns to each data packet, sent by said source unit, a payment token which has an initial value representing a credit of monetary units previously acquired from a toll center;
in said destination unit and/or in at least one node, called a debit node, located downstream of said at least one credit node, a debit gateway modifies the payment token assigned to each data packet received, so as to reduce said payment token initial value, by an amount representing the cost of the operations to be carried out, for said received packet, by said destination unit and/or said at least one debit node;
said destination unit and/or each debit node, in which a said debit gateway is included, receives from said toll center, for each packet received during said session, financial settlement of said representative amount;
characterised in that at least one of said payment tokens includes, apart from said initial value representing a credit of monetary units, at least one operation adaptation datum, allowing said destination unit and/or said at least one debit node to adapt:
the content of the operations to be carried out;
and/or the cost actually billed to said source unit and/or said at least one credit node, for carrying out said operations.

2. A process according to claim 1, characterised in that said at least one operation adaptation datum belongs to the group including data relating to the user, direct or indirect, of said source unit and/or said at least one credit node.

3. A process according to claim 2, characterised in that, in order to adapt the actually billed cost, said destination unit and/or said at least one debit node carries out the following stages:
determination of said actually billed cost, as a function of said at least one operation adaptation datum;
reduction of said payment token initial value, by a pre-set average amount representing the average cost of the operations to be carried out;
modification of the current value of an associated account relating to a user, direct or indirect, of said source unit and/or said at least one credit node, by addition or withdrawal of a sum as a function of the difference between said actually billed cost and said pre-set average amount.

4. A process according to claim 3, characterised in that said source unit is used by a provider of access to said data packet transmission network, and allows said access to be provided to at least one subscriber to said access provider, called an indirect user,
and in that said at least one operation adaptation datum is added to said packet by said access provider, and depends on the subscriber in respect of whom said access provider sends said packet.

5. A process according to claim 3, characterised in that said payment token is assigned to a given packet by insertion into said packet and/or into at least one higher level encapsulating structure of said packet.

6. A process according to claim 2, characterised in that, in order to adapt the actually billed cost, said destination unit and/or said at least one debit node carries out the following stages:
determination of said actually billed cost, as a function of said at least one operation adaptation datum;
reduction of said payment token initial value, by a pre-set average amount representing the average cost of the operations to be carried out;
return to said source unit and/or to said at least one credit node of a payment token which has a value function of the difference between said actually billed cost and said pre-set average amount, so that the value of said returned payment token is restored to a user, direct or indirect, of said source unit and/or said at least one credit node.

7. A process according to claim 6, characterised in that said source unit is used by a provider of access to said data packet transmission network, and allows said access to be provided to at least one subscriber to said access provider, called an indirect user,
and in that said at least one operation adaptation datum is added to said packet by said access provider, and depends on the subscriber in respect of whom said access provider sends said packet.

8. A process according to claim 6, characterised in that said payment token is assigned to a given packet by insertion into said packet and/or into at least one higher level encapsulating structure of said packet.

9. A process according to claim 2, characterised in that said source unit is used by a provider of access to said data packet transmission network, and allows said access to be provided to at least one subscriber to said access provider, called an indirect user,
and in that said at least one operation adaptation datum is added to said packet by said access provider, and depends on the subscriber in respect of whom said access provider sends said packet.

10. A process according to claim 9, characterised in that said addition stage by said access provider of said at least one operation adaptation datum is billed at least partly to said destination unit and/or said at least one debit node.

11. A process according to claim 2, characterised in that said data packet transmission network is a network of the Internet type.

12. A process according to claim 2, characterised in that said service operations belong to the group including:
information data supply operations;
video data supply operations;
audio data supply operations;
cartography data supply operations.

13. A process according to claim 1, characterised in that, in order to adapt the actually billed cost, said destination unit and/or said at least one debit node carries out the following stages:
determination of said actually billed cost, as a function of said at least one operation adaptation datum;
reduction of said payment token initial value, by a pre-set average amount representing the average cost of the operations to be carried out;
modification of the current value of an associated account relating to a user, direct or indirect, of said source unit and/or said at least one credit node, by addition or withdrawal of a sum as a function of the difference between said actually billed cost and said pre-set average amount.

14. A process according to claim 1, characterised in that, in order to adapt the actually billed cost, said destination unit and/or said at least one debit node carries out the following stages:
determination of said actually billed cost, as a function of said at least one operation adaptation datum;
reduction of said payment token initial value, by a pre-set average amount representing the average cost of the operations to be carried out;
return to said source unit and/or to said at least one credit node of a payment token which has a value function of the difference between said actually billed cost and said pre-set average amount, so that the value of said returned payment token is restored to a user, direct or indirect, of said source unit and/or said at least one credit node.

15. A process according to claim 1, characterised in that said source unit is used by a provider of access to said data packet transmission network, and allows said access to be provided to at least one subscriber to said access provider, called an indirect user,
and in that said at least one operation adaptation datum is added to said packet by said access provider, and depends on the subscriber in respect of whom said access provider sends said packet.

16. A process according to claim 15, characterised in that said addition stage by said access provider of said at least one operation adaptation datum is billed at least partly to said destination unit and/or said at least one debit node.

17. A process according to claim 1, characterised in that said payment token is assigned to a given packet by insertion into said packet and/or into at least one higher level encapsulating structure of said packet.

18. A process according to claim 1, characterised in that said data packet transmission network (4) is a network of the Internet type.

19. A process according to claim 1, characterised in that said service operations belong to the group including:
information data supply operations;
video data supply operations;
audio data supply operations;
cartography data supply operations.

20. A system for adapting the content and/or the cost of transmission and/or service operations carried out within a data packet transmission network, during a session between a source unit and a destination unit interconnected via at least one node of said network, said destination unit and/or said at least one node being used by at least one operator and/or at least one service provider, said process being such that:
said source unit and/or at least one node, called a credit node, includes a credit gateway making it possible to assign to each data packet, sent by said source unit, a payment token which has an initial value representing a credit of monetary units previously acquired from a toll centre;
said destination unit and/or at least one node, called a debit node, located downstream of said at least one credit node, includes a debit gateway making it possible to modify the payment token assigned to each data packet received, so as to reduce said payment token initial value, by an amount representing the cost of the operations to be carried out, for said received packet, by said destination unit and/or said at least one debit node;
said destination unit and/or each debit node, in which a said debit gateway is included, receives from said toll centre, for each packet received during said session, financial settlement of said representative amount;
characterised in that said system includes inclusion means in at least one of said payment tokens, apart from said initial value representing a credit of monetary units, of at least one operation adaptation datum,
and in that said destination unit and/or said at least one debit node includes adaptation means, as a function of said at least one operation adaptation datum:
of the content of the operations to be carried out;
and/or the cost actually billed to said source unit and/or to said at least one credit node, for carrying out said operations.
